(19) United States
(12) Patent Application Publication
(10) Pub. No.: US 2015/0063135 A1
(43) Pub. Date: Mar. 5, 2015

(54) CLIENT, SERVER, AND WIRELESS SIGNAL MAP CREATING SYSTEM USING THE SAME

(71) Applicant: Foundation of Soongsil University-lndustry Cooperation, Seoul (KR)

(72) Inventors: Young Tack PARK, Seoul (KR); In Cheol Kim, Seongnam-si (KR); Eun Mi Choi, Seoul (KR); Hui Kyung Oh, Seoul (KR)

(73) Assignee: Foundation of Soongsil University-lndustry Cooperation, Seoul (KR)

(21) Appl. No.: 14/091,486

(22) Filed: Nov. 27, 2013

(30) Foreign Application Priority Data
Aug. 27, 2013 (KR) 10-2013-0101744

(51) Int. Cl. H04W 24/08

(52) U.S. Cl. CPC H04W 24/08
USPC 370/252

(57) ABSTRACT

Provided are a client and a server which filter errors in signal data collected in a wireless signal map creating process and increase accuracy of a signal map, and a wireless signal map creating system using the same. The wireless signal map creating system collects a local wireless signal map, stores a global wireless signal map, calculates a predicted signal strength of a specific point using a reception strength of at least one point located adjacent to the specific point in the local wireless signal map, compares a wireless signal strength of the specific point in the local wireless signal map and a predicted signal strength to determine an error or not, and updates the global wireless signal map based on a determination result.

### CROSS-REFERENCE TO RELATED APPLICATION

This application claims the benefit under 35 U.S.C. §119(a) of Korean Patent Application No. 10-2013-0101744, filed on Aug. 27, 2013, the entire disclosure of which is incorporated herein by reference for all purposes.

### BACKGROUND

1. Field

The following description relates to a client and a server which are capable of creating and updating a wireless signal map by filtering an error of wireless signal data, and a wireless signal map creating system using the same.

2. Description of the Related Art

Recently, due to development of various location-based services for mobile terminal users, demands for more accurate real time location information are increasing. In order to extract real time location information, GPS is generally used. In an indoor environment having difficulty to receive GPS signals, location tracking technology using a WiFi signal is broadly used. The location tracking technology using a WiFi signal may be broadly divided into triangulation and fingerprinting. In the triangulation, locations of neighboring transmitters (AP) and a real time WiFi reception strength are used. In the fingerprinting, a WiFi signal map is made based on a WiFi signal data set collected from indoor spaces and is used. In general, due to high location tracking accuracy, the fingerprinting is widely used than the triangulation, but it has a problem in that a lot of time and efforts are required to build and update a signal map.

As a method of complementing the above problem, research on a crowd-sourced map creating method in which many general users cooperate voluntarily and create a signal map has been actively conducted. In general, a crowd-sourced map creating system includes a plurality of clients responsible for WiFi signal collection independently, and a server that builds a global WiFi signal map based on a plurality of pieces of signal data collected from the clients and provides the map to a client who needs the map. Most conventional crowd-sourced WiFi signal map creating systems employ a passive method in which a user directly inputs and modifies location information, which is an important element of the signal map. In addition, the conventional systems do not include sufficient features for filtering errors of signal data collected from many unspecified users.

### SUMMARY

It is an aspect of the present invention to provide a client and a server which filter errors in signal data collected in a wireless signal map creating process and increase accuracy of a signal map, and a wireless signal map creating system using the same.

In one general aspect, there is provided a server including, a server memory unit configured to store a global wireless signal map, a server communication unit configured to receive a local wireless signal map collected by at least one client, and a server control unit configured to compare a reception strength of a specific point in the local wireless signal map and a predicted signal strength of the specific point predicted in the global wireless signal map, and filter an error.

The server control unit may check signal strengths of a plurality of points located adjacent to the specific point in the global wireless signal map, and calculate the predicted signal strength using the signal strengths of the plurality of points located adjacent to the specific point.

The server control unit may set a weight that is inversely proportional to a distance between the plurality of points located adjacent to the specific point and the specific point, and calculate the predicted signal strength.

The server control unit may multiply the signal strengths of the plurality of points located adjacent to the specific point by the weight, respectively, perform linear combination of the weighted values, and calculate the predicted signal strength.

When a difference between the reception strength of the specific point in the local wireless signal map and the predicted signal strength is greater than a predetermined threshold, the server control unit may determine the reception strength of the specific point in the local wireless signal map as an error and delete a corresponding signal.

When a difference between the reception strength of the specific point in the local wireless signal map and the predicted signal strength is less than or equal to a predetermined threshold, the server control unit may determine that the reception strength of the specific point in the local wireless signal map is not an error, and update the global wireless signal map.

In another aspect, there is provided a wireless signal map updating system including, at least one client configured to collect a local wireless signal map, and a server configured to store a global wireless signal map, calculate a predicted signal strength of a specific point using a reception strength of at least one point located adjacent to the specific point in the local wireless signal map, compare a wireless signal strength of the specific point in the local wireless signal map and the predicted signal strength to determine an error or not, and update the global wireless signal map based on a determination result.

When the server calculates a predicted signal strength of the specific point using the reception strength of the at least one point located adjacent to the specific point in the local wireless signal map, a weight that is inversely proportional to a distance between the at least one point located adjacent to the specific point and the specific point may be set to calculate the predicted signal strength.

The server may multiply signal strengths of a plurality of points located adjacent to the specific point by the weight, respectively, perform linear combination of the weighted values, and calculate the predicted signal strength.

In the determining of the error by comparing the wireless signal strength of the specific point in the local wireless signal map and the predicted signal strength, when a difference between the reception strength of the specific point in the local wireless signal map and the predicted signal strength is greater than a predetermined threshold, it may be determined that the reception strength of the specific point in the local wireless signal map is an error.

In the determining of the error by comparing the wireless signal strength of the specific point in the local wireless signal map and the predicted signal strength, when a difference between the reception strength of the specific point in the local wireless signal map and the predicted signal strength is less than or equal to a predetermined threshold, it may be determined that the reception strength of the specific point in the local wireless signal map is not an error.

In still another aspect, there is provided a client including, a client memory unit configured to store a global wireless signal map, and a client control unit configured to collect a local wireless signal map, compare a reception strength of a specific point in the local wireless signal map and a predicted signal strength of the specific point predicted in the global wireless signal map, and filter an error.

In yet another aspect, there is provided a server including, a server memory unit configured to store a global wireless signal map, and a server control unit configured to collect a local wireless signal map, compare a reception strength of a specific point in the local wireless signal map and a predicted signal strength of the specific point predicted in the global wireless signal map, and filter an error.

### BRIEF DESCRIPTION OF THE DRAWINGS

FIG. 1A is a schematic block diagram illustrating a wireless signal map creating system according to an embodiment of the invention.

FIG. 1B is a schematic block diagram illustrating a wireless signal map creating system according to another embodiment of the invention.

FIG. 1C is a schematic block diagram illustrating a wireless signal map creating system according to still another embodiment of the invention.

FIG. 2 is a diagram illustrating a DBN model for describing a WiFi SLAM used in the wireless signal map creating system according to the embodiment of the invention.

FIG. 3 is an illustration of a program algorithm for describing the WiFi SLAM used in the wireless signal map creating system according to the embodiment of the invention.

FIG. 4 is a diagram illustrating a motion model based on a virtual pedometer of the WiFi SLAM used in the wireless signal map creating system according to the embodiment of the invention.

FIG. 5 is a diagram describing a method of calculating the number of steps using an accelerometer of the WiFi SLAM used in the wireless signal map creating system according to the embodiment of the invention.

FIG. 6 is an illustration of an algorithm for calculating the number of steps using an accelerometer of the WiFi SLAM used in the wireless signal map creating system according to the embodiment of the invention.

FIG. 7 is a diagram illustrating a Gaussian interpolation-based WiFi observation model of the WiFi SLAM used in the wireless signal map creating system according to the embodiment of the invention.

FIG. 8 is a diagram illustrating estimation of a current location in a particle set of the WiFi SLAM used in the wireless signal map creating system according to the embodiment of the invention.

FIG. 9 is a diagram illustrating a method of eliminating errors in a wireless signal delivered from a client in a server of the wireless signal map creating system according to the embodiment of the invention.

FIG. 10 is an illustration of an algorithm for upgrading a wireless signal map in the wireless signal map creating system according to the embodiment of the invention.

FIG. 11 is a flowchart illustrating a wireless signal map creating method according to an embodiment of the invention.

FIG. 12 is a flowchart illustrating a wireless signal map creating method according to another embodiment of the invention.

FIG. 13 is a flowchart illustrating a wireless signal map creating method according to still another embodiment of the invention.

### DETAILED DESCRIPTION

Hereinafter, exemplary embodiments of the invention will be described in detail with reference to the accompanying drawings. Elements that appear in more than one drawing or are mentioned in more than one place in the detailed description will be consistently denoted by the same respective reference numerals.

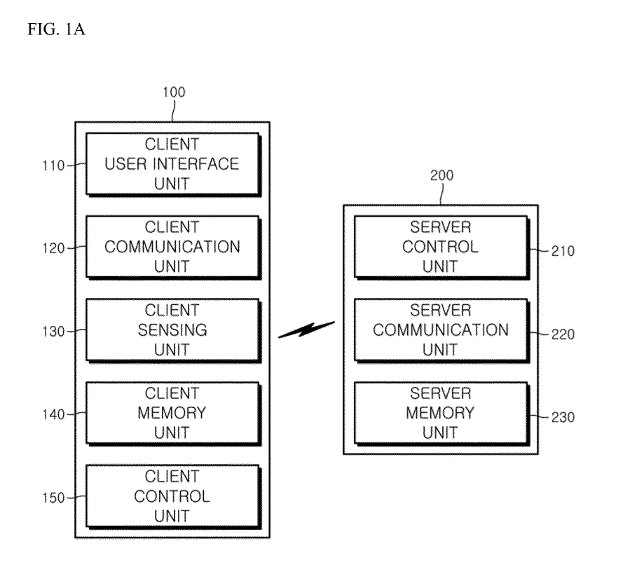

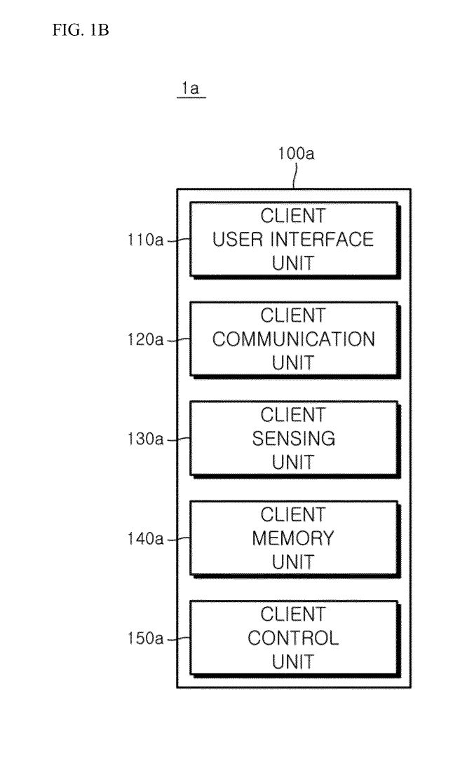

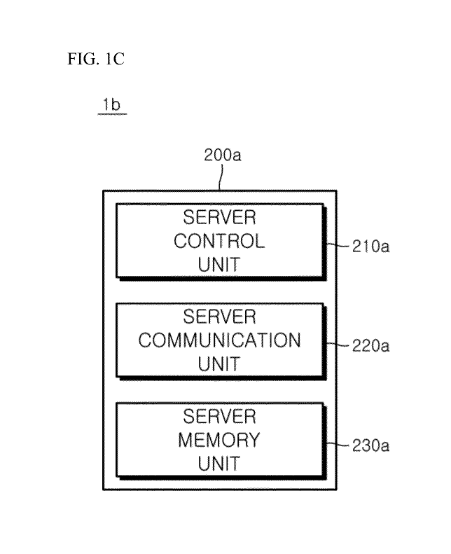

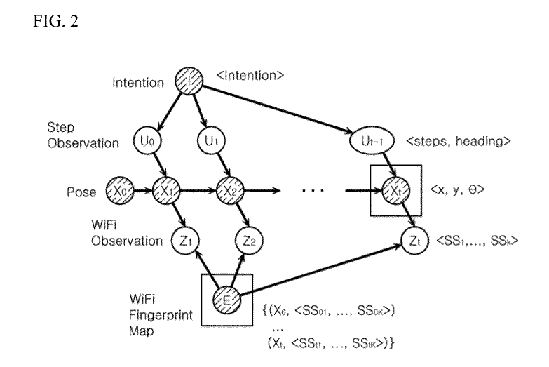

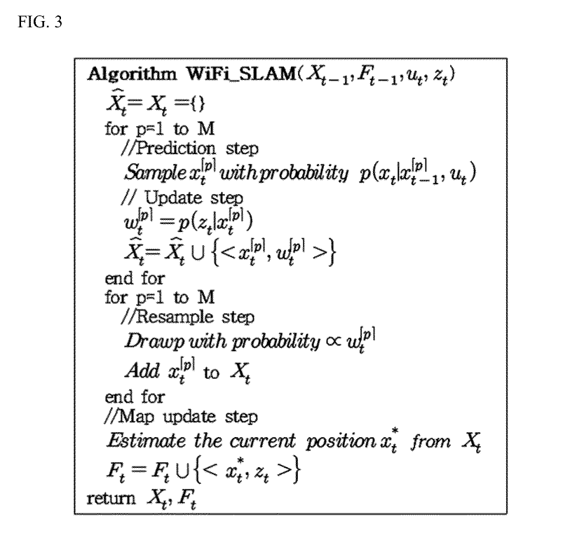

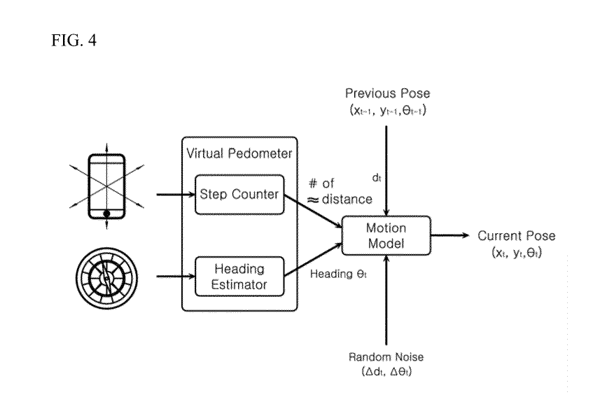

FIGS. 1A to 1C are schematic block diagrams illustrating a wireless signal map creating system according to an embodiment of the invention. FIG. 2 is a diagram illustrating a DBN model for describing a WiFi SLAM used in the wireless signal map creating system according to the embodiment of the invention. FIG. 3 is an illustration of a program algorithm for describing the WiFi SLAM used in the wireless signal map creating system according to the embodiment of the invention. FIG. 4 is a diagram illustrating a motion model based on a virtual pedometer of the WiFi SLAM used in the wireless signal map creating system according to the embodiment of the invention.

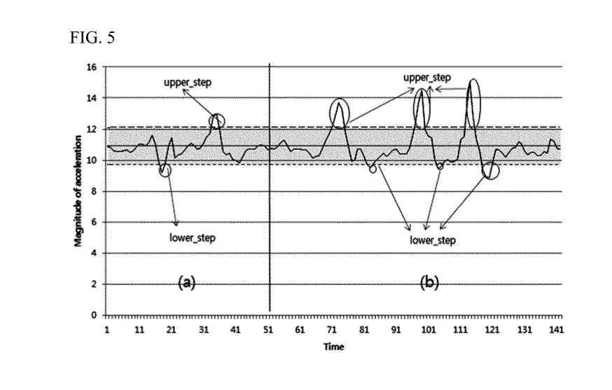

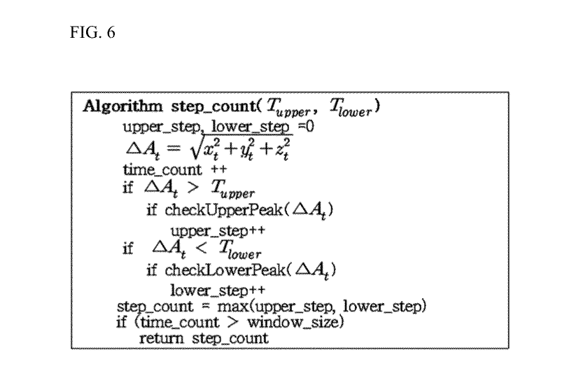

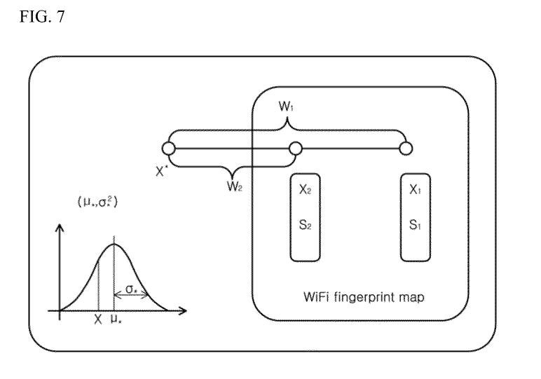

FIG. 5 is a diagram describing a method of calculating the number of steps using an accelerometer of the WiFi SLAM used in the wireless signal map creating system according to the embodiment of the invention. FIG. 6 is an illustration of an algorithm for calculating the number of steps using an accelerometer of the WiFi SLAM used in the wireless signal map creating system according to the embodiment of the invention. FIG. 7 is a diagram illustrating a Gaussian interpolation-based WiFi observation model of the WiFi SLAM used in the wireless signal map creating system according to the embodiment of the invention.

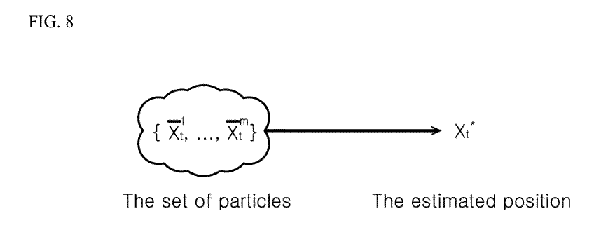

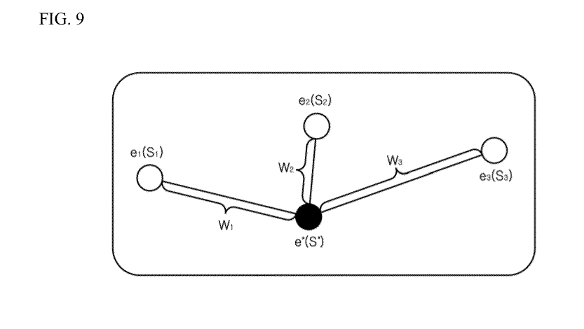

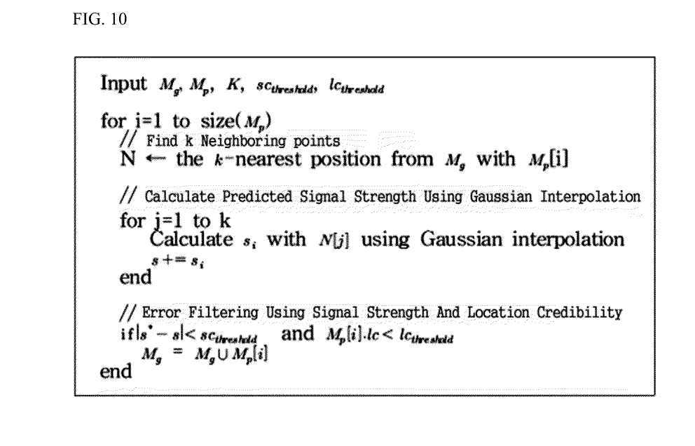

FIG. 8 is a diagram illustrating estimation of a current location in a particle set of the WiFi SLAM used in the wireless signal map creating system according to the embodiment of the invention. FIG. 9 is a diagram illustrating a method of eliminating errors in a wireless signal delivered from a client in a server of the wireless signal map creating system according to the embodiment of the invention. FIG. 10 is an illustration of an algorithm for upgrading a wireless signal map in the wireless signal map creating system according to the embodiment of the invention.

As illustrated in FIG. 1A, a wireless signal map creating system 1 includes a client 100 and a server 200. As illustrated in FIG. 1B, a wireless signal map creating system 1a may include only a client 100a. As illustrated in FIG. 1C, a wireless signal map creating system 1b may include only a server 200a.

Hereinafter, description will be given based on FIG. 1A in which the wireless signal map creating system 1 includes both of the client 100 and the server 200. In FIG. 1B, the client 100a may perform functions of the client 100 and the server 200 in FIG. 1A. In FIG. 1C, the server 200a may perform functions of the client 100 and the server 200 in FIG. 1A.

As illustrated in FIG. 1A, the client 100 may include a client user interface unit 110 configured to receive user manipulation, a client communication unit 120 configured to communicate with an external device, a client sensing unit 130 configured to detect acceleration or a moving direction, a client memory unit 140 configured to store a signal map, and a client control unit 150 configured to manage overall control of the client 100.

The client user interface unit 110 may include various input units capable of receiving a user's input such as a button and a touch panel.

The client communication unit 120 may receive a wireless signal from at least one nearby wireless access point (AP). The client communication unit 120 may transmit and receive the wireless signal with the server 200. The client communication unit 120 may transmit and receive data on a signal map with the server 200.

The client sensing unit 130 may include an accelerometer and a magnetic sensor. The accelerometer is a sensor for detecting acceleration of a moving object or an intensity of impact, and is able to detect a user's movement. The accelerometer may calculate a user movement distance using acceleration change information. The accelerometer may be a 3-axis accelerometer configured to measure 3-axis acceleration, and may include all types of accelerometers such as an inertia-type, a gyro-type, or a silicon semiconductor-type accelerometer. The magnetic sensor is a sensor for detecting a magnetic field change due to object movement, and uses, for example, the Hall effect causing a voltage change when a magnetic field is perpendicularly applied to a current flowing through a semiconductor. The magnetic sensor may be used as various terms such as a digital compass, or a geomagnetic sensor. In the embodiment, all sensors configured to detect a magnetic field change are referred to as the magnetic sensor.

The client memory unit 140 may store a program capable of implementing a WiFi simultaneous localization and mapping (SLAM) function. The SLAM is technology capable of simultaneous location tracking and automatically creating a signal map.

The client control unit 150 may implement the WiFi SLAM function and perform overall control of the client 100. Specifically, as shown in Formula 1, the SLAM is a process of tracking a real time location xₜ of an object and creating a map m of a corresponding space at the same time using movement information u_{1:t} of the object in an unknown space and sensor data z_{1:t}.

p(xₜ, m|z_{1:t},u_{1:t})

In FIG. 2, the DBN model is represented. The DBN model refers to a dynamic Bayesian network (DBN) representing dependence between state variables over time with one probability graph. In FIG. 2, uₜ₋₁ and zₜ represents steps of a pedestrian who is a smartphone user and a heading WiFi observation value. It is assumed that steps of the pedestrian and the heading uₜ₋₁ are determined by the user's intention, and the WiFi observation value zₜ is influenced by a current location xₜ of the smartphone user and a WiFi signal environment E. Therefore, a predicted WiFi observation value may be represented as a likelihood probability p(zₜ|xₜ,E) called a WiFi observation model. Meanwhile, it is assumed that the real time location xₜ of the pedestrian may be estimated from a previous location xₜ₋₁, moving steps, and the heading uₜ₋₁. p(zₜ|xₜ₋₁,uₜ₋₁) as probabilistic representation of this estimation is referred to as a motion model.

A WiFi SLAM inference algorithm using a particle filter will be described with reference to FIG. 3. The particle filter is one of approximation methods of an efficient Bayesian filter for location tracking in continuous spaces. The particle filter-based WiFi SLAM algorithm repeats a loop process of four steps in total including prediction, updating, resampling, and signal map updating.

In a prediction step, a pedestrian motion model using an accelerometer and an orientation sensor is used to predict a next location of each particle. In an updating step, the WiFi observation model is applied to a newly received WiFi signal and a weight of each particle proportional to an observation likelihood is calculated. In a resampling step, a new particle set is selected probabilistically in proportion to weights of the particles. In a signal map updating step, a current location xₜ* of the user is obtained from the particle set, and is reflected to the WiFi signal map with the received WiFi observation value zₜ.

In the WiFi SLAM, location tracking performance is greatly affected by accuracy of the pedestrian motion model, and thus an accurate pedestrian motion model is necessary. The most important elements of the pedestrian motion model include the number of steps and a moving direction (heading). According to one aspect of the invention, the number of steps of the pedestrian is calculated using a variation of accelerometer values, and the heading of the pedestrian is obtained using an orientation sensor value. As illustrated in FIG. 4, in the pedestrian motion model, a heading θt is obtained using the number of steps estimated using the accelerometer value and an average stride of the pedestrian. A new location (xₜ, yₜ, θₜ) may be obtained by moving by a distance dt and an angle θt from a previous location (xₜ₋₁, yₜ₋₁, θₜ₋₁). In this case, in consideration of sensor measurement errors and space characteristics, it is possible to represent uncertainty by adding a movement distance noise Δdₜ and an orientation noise Δθₜ.

In estimation of the number of steps, ΔA=\sqrt{x²+y²+z²}, which is the square root of sum of squares for x, y, and z values of the 3-axis accelerometer built in the smartphone, is obtained and a variance thereof may be obtained. In the method of calculating the number of steps, the numbers of peak points and bottom points in ΔA values for a predetermined time are counted and a great value is selected from the numbers of peak points and bottom points. However, since the ΔA value continuously changes even when the smartphone user is standing still, in order to identify the peak point and the bottom point which are only generated in walking movement, an upper threshold (T_{UPPER}) and a lower threshold (T_{lower}) are determined and it is possible to select a great value from the numbers of peak points and bottom points above and below the thresholds. FIG. 5A is a graph representing a variation of ΔA when the user walked one step, and includes one peak point above the upper threshold (Tᵤₚₚₑᵣ) and one bottom point below the lower threshold (T_{lower}). FIG. 5B is a graph representing a variation of ΔA when the user walked three steps consecutively, and includes three peak points above the upper threshold (Tᵤₚₚₑᵣ) and three bottom points below the lower threshold (T_{lower}). Based on the method of estimating the number of steps, FIG. 6 describes an algorithm for calculating the number of steps using a variation of accelerometer values.

In a fingerprint recognition location tracking method, a probability distribution of a WiFi reception strength for each region is obtained from training data collected in an off-line step, and an observation likelihood may be calculated using the training data when real time location tracking is performed. In the embodiment, a Gaussian interpolation-based WiFi observation model may be used to calculate an observation likelihood of an arbitrary region where training data collection is not performed from neighboring regions that have been already been notified of a WiFi signal strength probability distribution. The Gaussian interpolation-based WiFi observation model may use the following two basic assumptions with respect to the WiFi reception strength. One assumption is that signal strengths for each AP received in each region may be represented as a normal probability distribution. Another assumption is that signal strengths for separate APs received in the same region may be independent of each other.

As illustrated in FIG. 7, it is possible to predict a WiFi reception likelihood probability distribution of a new point x* from neighboring points x₁ and x₂ that have been already notified of the WiFi reception likelihood probability distribution, using the following method. As shown in Formula 2, a contribution degree of the WiFi reception probability distribution of x₁ and x₂ to prediction of the WiFi reception probability distribution of x* follows a distance from x*, that is, a weight wᵢ inversely proportional to |xᵢ, x*|.

$${w}_{i} = k ( {x}_{i} , {x}^{*} ) = exp ( - \frac{1}{{2}_{τ}^{2}} \vert {x}_{i} - {x}^{*} \vert ) \qquad Formula 2$$

As shown in Formula 3, an average uᵢ and a variance σᵢ², which are Gaussian probability distribution parameters of neighboring points, are multiplied by a weight wᵢ, the weighted values are linearly combined, and thus a reception strength probability distribution of an arbitrary region x* may be easily calculated.

$${μ}_{*} = {\sum }_{i = 1}^{n} {w}_{i} \cdot {μ}_{i} {σ}_{*}^{2} = {\sum }_{i = 1}^{n} {w}_{i} \cdot {σ}_{i}^{2} \qquad Formula 3$$

In a location tracking step, the WiFi reception probability distribution of an arbitrary location x* indicated by each particle is calculated using the above method, and a likelihood probability of a new WiFi observation value z may be calculated using the WiFi reception probability distribution as shown in Formula 4.

$$p ( z \vert {x}^{*} ) = \frac{1}{\sqrt{2 {πσ}_{*}^{2}}} exp ( - \frac{{( z - {μ}_{*} )}^{2}}{2 {σ}_{*}^{2}} ) \qquad Formula 4$$

The WiFi reception probability distribution of neighboring points to be used for Gaussian interpolation in the WiFi SLAM may be derived from map training data included in a current WiFi signal map. However, when all training data registered in the signal map is used to calculate an observation likelihood of a specific point x*, since it is difficult to satisfy real time measurement due to increased computation, it is necessary to select a signal data subset to be referenced in calculation actually. In the particle filter, the particle set represents a probability distribution of the pedestrian's location. Since a generated WiFi signal map may differ based on the user's location, a method in which an independent WiFi signal map for each particle is stored and managed in a particle filter algorithm for the WiFi SLAM may be used. However, since this method requires a large storage space and computational complexity, a single WiFi signal map shared by all particles may be designed for a real time WiFi SLAM operated in a client in the embodiment. It is necessary to add a pair of a current location and a WiFi observation value to this WiFi signal map in the map updating step. Therefore, as illustrated in FIG. 8, it is necessary to estimate one current location xₜ* of the user based on the particle set every moment. In a current location determining method according to an embodiment of the invention, a weight centroid is obtained using weights wit of each particle, and is determined as a current location of the user. The weight centroid is calculated as a weighted average value of each particle location as shown in Formula 5.

$${x}_{i}^{*} = {\sum }_{i}^{m} {w}^{{i}_{t}} \cdot \vec{{x}^{{t}^{i}}} {\sum }_{i = 1}^{m} {w}_{t}^{i} = 1 \qquad Formula 5$$

It is necessary to determine just one user location from the particle set including all possible candidates of the user location for updating the WiFi signal map. Thus, an estimated user current location implies potential uncertainty. The uncertainty of the estimated user current location may be evaluated using a variance indicating distribution of particles around the estimated location as shown in Formula 6.

$${υ}_{t}^{*} = \frac{1}{m} {\sum }_{i}^{m} {( \vec{{x}_{t}^{i}} - {x}_{t}^{*} )}^{2} \qquad Formula 6$$

Credibility of the estimated location is inversely proportional to the uncertainty and is calculated using Formula 7.

cₜ*=1/vₜ* Formula 7

As shown in Formula 8, each signal map data stored in the WiFi signal map may include an estimated location xₜ* of the user, a WiFi signal observation value sₜ of the location, and a location credibility cₜ*. As shown in Formula 9, location information may include, for example, a location label, location coordinates, and a visiting time.

eₜ=(xₜ*, sₜ, cₜ*) Formula 8

xt*=(location_label, location_coordinate, visiting_time) Formula 9

When only visiting locations over time are selected from the WiFi signal map, it is possible to easily obtain a user trajectory as shown in Formula 10.

T=<x₀*,x₁*, . . . , xₜ*> Formula 10

The server 200 may include a server control unit 210 configured to manage overall is control, a server communication unit 220 configured to communicate with the client 100, and a server memory unit 230 configured to store a signal map.

The server control unit 210 receives signal map information from at least one client 100, builds a large-scale global WiFi signal map, and may filter error data due to various causes such as malfunctions of the client sensing unit 130 provided in the client 100 and a temporary change of the WiFi signal.

Based on a basic assumption of the WiFi signal strength in which a similar WiFi signal strength is received in an adjacent location, the server control unit 210 compares signals collected by the client 100 and signals collected in an adjacent location in the signal map registered in the server memory unit 230, checks signal strength similarity, and may determine an error based on the similarity result. As described above, the server control unit 210 may use a Gaussian process method that is a non-parametric estimation method used when an entire probability distribution of the signal map is unknown. The Gaussian process (GP) is infinite-dimensional generalization of random variables having a Gaussian distribution in the probability space. Using the non-parametric method, it is suitable for random process estimation with complexity and big noise. In the Gaussian process, using Gaussian interpolation, poor real time processing due to high computational complexity may be improved and computational complexity may be decreased. As a modification of the Gaussian process, in the Gaussian interpolation, a distribution function of an overall signal strength in the WiFi signal map is not assumed in advance, and a neighboring signal is used to calculate a predicted signal strength when a signal is generated.

The server control unit 210 may perform a signal map consistency check using the Gaussian interpolation. As illustrated in FIG. 9, the server control unit 210 calculates a contribution degree of k neighboring points e₁, e₂, and e₃ that have already been notified of the WiFi reception strength in the server 200 to predict a WiFi reception strength of a new point e* collected from the client, using a distance from e*, that is, a weight wᵢ inversely proportional to |e*−eᵢ|, as shown in Formula 11. As shown in Formula 12, the WiFi reception strength of neighboring points is multiplied by a weight wᵢ, the weighted values are linearly combined, and thus a predicted WiFi signal strength of an arbitrary region e* may be calculated.

$$\begin{matrix}{w}_{i} = k ( {e}_{i} , {e}^{*} ) = exp ( - \frac{1}{{2}_{τ}^{2}} \vert {e}_{i} - {e}^{*} \vert ) & Formula 11 \\ s = {\sum }_{i = 1}^{n} {w}_{i} \cdot {s}_{i} & Formula 12\end{matrix}$$

The server control unit 210 calculates a difference between a WiFi signal strength s predicted using the Gaussian interpolation and a WiFi signal strength s* of an actual e*, deletes a corresponding signal when the difference is greater than the threshold, and updates an integrated signal map (Mg, or a global signal map) with the information when the difference is less than or equal to the threshold. These operations may be represented as Formula 13. A signal map updating algorithm may be described as FIG. 10.

|s*−s<sc_{threshold} Formula 13

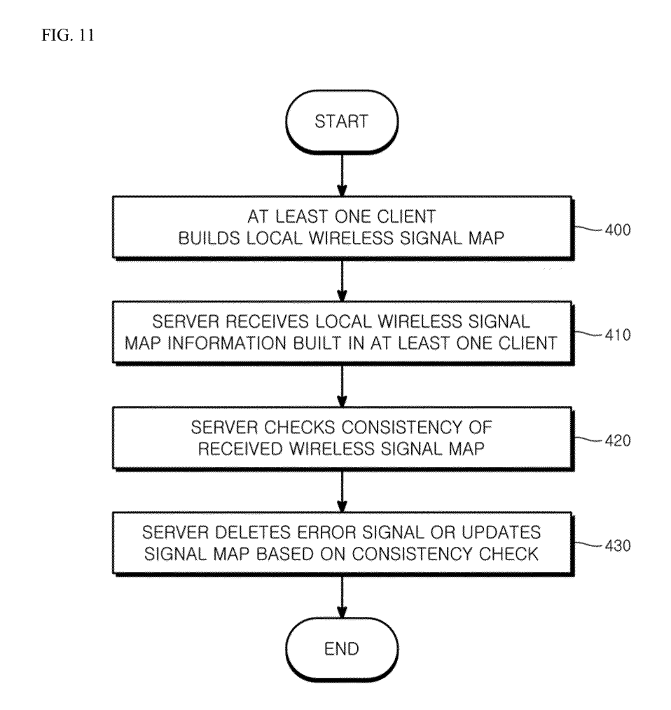

FIG. 11 is a flowchart describing a wireless signal map creating method according to an embodiment of the invention.

FIG. 11 is a flowchart corresponding to FIG. 1A. The client 100 includes a WiFi SLAM algorithm capable of tracking a real time location using embedded sensors without a wireless signal map and building a local WiFi signal map at the same time. At least one client 100 builds the WiFi signal map and transmits the WiFi signal map information to the server 200.

The server 200 receives the WiFi signal map information from the at least one client 100 and checks consistency of the received WiFi signal map so as to change a local signal map received from the at least one client 100 to a global signal map. On the assumption that a similar WiFi signal strength is received in an adjacent location, the server 200 compares signals collected by the client 100 and signals collected in an adjacent location in the signal map registered in the server 200, and may compare signal strength similarity. The server 200 predicts a WiFi reception strength of a new point collected by the client 100 from k neighboring points that have already been notified of the WiFi reception strength in the server 200. In reception strength prediction of the new point, the server 200 calculates a weight Wᵢ that is inversely proportional to a distance between the new point and an already known point. The server 200 multiplies the WiFi reception strength of the neighboring points by the weight Wᵢ, the weighted values are linearly combined, and thus the WiFi signal strength of the new point may be calculated.

The server 200 compares the wireless signal strength collected by the client 100 and an expected wireless signal strength predicted using the Gaussian interpolation, deletes a corresponding signal when the difference is greater than the threshold, and reflects and updates an integrated signal map with the information when the difference is less than or equal to the threshold.

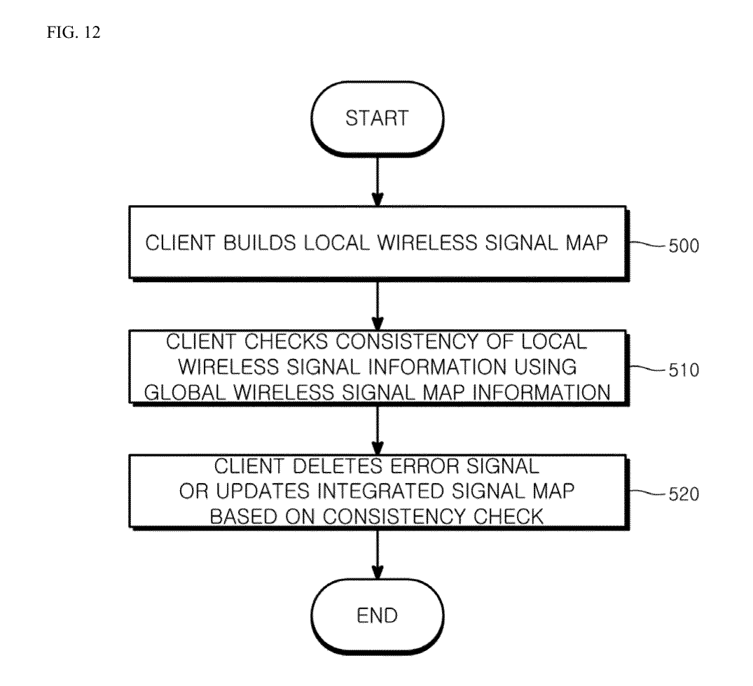

FIG. 12 is a flowchart describing a wireless signal map creating method according to another embodiment of the invention.

FIG. 12 is a flowchart corresponding to FIG. 1B. The client 100a performs all functions described in FIG. 11. That is, functions of the server control unit 210 and the server memory unit 230 in FIG. 11 may be performed by a client control unit 150a and a client memory unit 140a, respectively.

Specifically, the client 100a includes a WiFi SLAM algorithm capable of tracking a real time location using embedded sensors without a wireless signal map and building a local WiFi signal map at the same time. The client 100a builds the local WiFi signal map (500).

The client 100a checks consistency of the local WiFi signal map using a pre-stored global signal map. On the assumption that a similar WiFi signal strength is received in an adjacent location, the client 100a compares a collected signal strength and signals collected in an adjacent location in the signal map registered in the client memory unit 140a, and may compare signal strength similarity. The client 100a predicts a WiFi reception strength of a new point collected from k neighboring points that have been notified of the WiFi reception strength in the global signal map.

In reception strength prediction of the new point, the client 100a calculates a weight W, that is inversely proportional to a distance between the new point and an already known point. The client 100a multiplies the WiFi reception strength of the neighboring points by the weight Wᵢ, the weighted values are linearly combined, and thus the WiFi signal strength of the new is point may be calculated (510).

The client 100a compares a newly collected wireless signal strength and an expected wireless signal strength predicted using the Gaussian interpolation, deletes a corresponding signal when the difference is greater than the threshold, and reflects and updates an integrated signal map (or global signal map) with the information when the difference is less than or equal to the threshold (520).

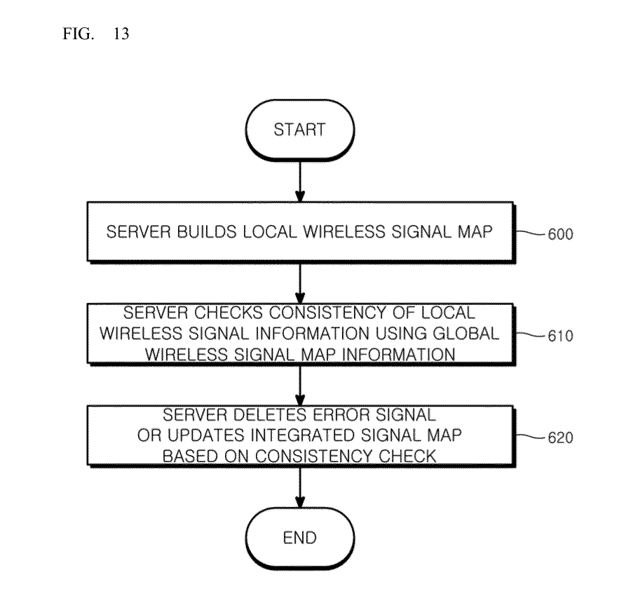

FIG. 13 is a flowchart corresponding to FIG. 1C. All functions described in FIG. 11 are performed by the server 200a. That is, functions of the client control unit 150 and the client memory unit 140 in FIG. 11 may be performed by a server control unit 210a and a server memory unit 230a, respectively.

The server 200a includes a WiFi SLAM algorithm capable of tracking a real time location using embedded sensors without a wireless signal map and building a local WiFi signal map at the same time (600).

The server 200a checks consistency of a received wireless signal map. On the assumption that a similar wireless signal strength is received in an adjacent location, the server 200a compares a newly collected signal strength and signals collected in an adjacent location in the signal map that is previously stored in the server 200a, and may compare signal strength similarity. The server 200a predicts a wireless reception strength of a new point collected by the client 100 from k neighboring points that have been notified of the WiFi reception strength in an integrated wireless signal map in the server memory unit 230a. In reception strength prediction of the new point, the server 200a calculates a weight Wᵢ that is inversely proportional to a distance between the new point and an already known point. The server 200a multiplies the WiFi reception strength of the neighboring points by the weight Wᵢ, the weighted values are linearly combined, and thus a predicted signal strength of the new point may be calculated (610).

The server 200a compares a wireless signal strength collected by the client 100 and an expected wireless signal strength predicted using the Gaussian interpolation, deletes a corresponding signal when the difference is greater than the threshold, and reflects and updates an integrated signal map with the information when the difference is less than or equal to the threshold (620).

According to the aspect of the invention, it is possible to detect errors in a local wireless signal map and update a global wireless signal map accurately.

While exemplary embodiments of the invention have been described, it will be understood by those skilled in the art that various modifications and changes may be made without departing from the spirit and scope of the invention as defined by the appended claims.

What is claimed is:

1. A server comprising:
a server memory unit configured to store a global wireless signal map;
s a server communication unit configured to receive a local wireless signal map collected by at least one client; and
a server control unit configured to compare a reception strength of a specific point in the local wireless signal map and a predicted signal strength of the specific point predicted in the global wireless signal map, and filter an error.

2. The server according to claim 1, wherein the server control unit checks signal strengths of a plurality of points located adjacent to the specific point in the global wireless signal map, and calculates the predicted signal strength using the signal strengths of the plurality of points located adjacent to the specific point.

3. The server according to claim 2, wherein the server control unit sets a weight that is inversely proportional to a distance between the plurality of points located adjacent to the specific point and the specific point, and calculates the predicted signal strength.

4. The server according to claim 3, wherein the server control unit multiplies the signal strengths of the plurality of points located adjacent to the specific point by the weight, respectively, performs linear combination of the weighted values, and calculates the predicted signal strength.

5. The server according to claim 1, wherein, when a difference between the reception strength of the specific point in the local wireless signal map and the predicted signal strength is greater than a predetermined threshold, the server control unit determines the reception strength of the specific point in the local wireless signal map as an error and deletes a corresponding signal.

6. The server according to claim 1, wherein, when a difference between the reception strength of the specific point in the local wireless signal map and the predicted signal strength is less than or equal to a predetermined threshold, the server control unit determines that the reception strength of the specific point in the local wireless signal map is not an error, and updates the global wireless signal map.

7. A wireless signal map updating system comprising:
at least one client configured to collect a local wireless signal map; and
a server configured to store a global wireless signal map, calculate a predicted signal strength of a specific point using a reception strength of at least one point located adjacent to the specific point in the local wireless signal map, compare a wireless signal strength of the specific point in the local wireless signal map and the predicted signal strength to determine an error or not, and update the global wireless signal map based on a determination result.

8. The system according to claim 7, wherein, when the server calculates a predicted signal strength of the specific point using the reception strength of the at least one point located adjacent to the specific point in the local wireless signal map, a weight that is inversely proportional to a distance between the at least one point located adjacent to the specific point and the specific point is set to calculate the predicted signal strength.

9. The system according to claim 8, wherein the server multiplies signal strengths of a plurality of points located adjacent to the specific point by the weight, respectively, performs linear combination of the weighted values, and calculates the predicted signal strength.

10. The system according to claim 7, wherein, in the determining of the error by comparing the wireless signal strength of the specific point in the local wireless signal map and the predicted signal strength, when a difference between the reception strength of the specific point in the local wireless signal map and the predicted signal strength is greater than a predetermined threshold, it is determined that the reception strength of the specific point in the local wireless signal map is an error.

11. The system according to claim 7, wherein, in the determining of the error by comparing the wireless signal strength of the specific point in the local wireless signal map and the predicted signal strength, when a difference between the reception strength of the specific point in the local wireless signal map and the predicted signal strength is less than or equal to a predetermined threshold, it is determined that the reception strength of the specific point in the local wireless signal map is not an error.

12. A client comprising:
a client memory unit configured to store a global wireless signal map; and
a client control unit configured to collect a local wireless signal map, compare a reception strength of a specific point in the local wireless signal map and a predicted signal strength of the specific point predicted in the global wireless signal map, and filter an error.

13. A server comprising:
a server memory unit configured to store a global wireless signal map; and
a server control unit configured to collect a local wireless signal map, compare a reception strength of a specific point in the local wireless signal map and a predicted signal strength of the specific point predicted in the global wireless signal map, and filter an error.
